(19) United States
(12) Patent Application Publication
(10) Pub. No.: US 2006/0185675 A1
(43) Pub. Date: Aug. 24, 2006

(54) Customizable facial seal for masks delivering breathing gases in positive pressure ventilation systems

(76) Inventor: Wayne Colin, Lexington, KY (US)

Correspondence Address: FRANCIS LAW OFFICE, PLLC, 271 W SHORT ST, STE 507, LEXINGTON, KY, 40507, US

(21) Appl. No.: 11/316,277

(22) Filed: Dec. 22, 2005

Related U.S. Application Data
(60) Provisional application No. 60/638,994, filed on Dec. 22, 2004.

(51) Int. Cl. A62B 18/02; A62B 18/08

(52) U.S. Cl. 128/206.24; 128/206.27; 128/206.28; 128/206.21

(57) ABSTRACT

This device is a facial seal containing an internal bladder that is filled or pressurized with a quick set compound while on the face of the patient. The quick set compound conforms to the face of the wearer while in the seal itself, resulting in a better, substantially leakproof, fit. This is critical in applications where breathing gases are being supplied to the patient at greater than air pressure. One such application involves inflating the airway for the treatment of obstructive sleep apnea.

### CROSS REFERENCE TO RELATED APPLICATIONS

This application claims priority from U.S. Provisional Application No. 60/638,994 filed on Dec. 22, 2004. This application relates to customizable seals for positive pressure ventilation systems that deliver breathing gases to medical patients. The entire disclosure contained in U.S. Provisional Application No. 60/638,994 including the attachments thereto, are incorporated herein by reference.

### BACKGROUND OF THE INVENTION

1. Field of the Invention

The present invention relates, in general, to respiratory masks and mask couplings and more particularly to customizable, flexible seals positioned between the mask and face that conform to the face of the wearer and that are intended for use with positive pressure ventilation systems.

2. Problems in the Art.

A variety of respiratory masks are known in the art. The function of the mask is determinative of its design and construction. Regardless of such function, a primary problem with respiratory masks is their inability to adequately form a seal between the mask and face of the wearer. This is true for masks which cover the nose, mouth, mouth and nose, and face.

Masks for positive pressure systems are especially susceptible to leakage since they are required to deliver air and prescribed gases at a pressure higher than that of the surrounding environment. The higher pressure gases within the mask environment will fill any void created by movement of the seal and mask thus can force a leak at weak points and points of minimal contact between the seal and face.

Often the necessary delivery of gases must overcome physical blockages within the respiratory tract, thus increasing the need for the mask and seal to maintain sufficient pressure within the airway by preventing leaks. This is especially critical in positive pressure systems used to treat obstructive sleep apnea.

Individuals suffering from obstructive sleep apnea require a minimum pressure to open their obstructed airway. The greater the air pressure the more likely a leak is to occur. When a leak occurs between the mask seal and face, the natural response is to more firmly apply the mask to the face. If the pressure is too great then the discomfort level may discourage the patient from following the prescribed treatment. If the mask and seal fail to prevent leaks and maintain sufficient pressure to open the obstructed airway, breathing is affected and apnea results which causes dangerous interruptions in REM sleep and harmful oxygen desaturation.

Leakage can occur as a result of many different circumstances. The seal material can soften over time from exposure to the oils excreted by the skin. The patient may tend to move in his or her sleep, thus moving the mask out of its ideal position. Normal facial movements during sleep can cause the mask's position to shift. The most troublesome, and preventable, is the fact that not everyone has the same facial structure thus one seal does not adequately fit everyone. Customs seals, while possible, have not been convenient or economical.

Patients using commercially available masks often compensate for leakage by incrementally tightening the mask over time as leakage worsens with each use. Excessive tightening can result in increased discomfort, facial indentions and marks, skin breakdown and ulceration, and damage to the mask. Leakage and attendant need for manipulation of the mask increases the probability that the patient will not follow the prescribed therapy thus not receive any therapeutic value.

Seals currently available include smooth seals which can be hollow or flexible but which have a pre-existing shape and contour that is difficult to adapt to differing facial structures. Flap seals are also utilized and depend upon the pressure within the mask to help create a tight seal around the face by applying pressure on the side of the seal opposite of the face. Finally there are gel filled seals which can leak their contents and offer little to no resistance to deformation of the seal between the face and mask.

The need for masks which deform to provide sealing along contours and crevices of the face has been described in numerous patent applications. U.S. Pat. No. 5,592,938, Mask Apparatus by Scarberry et al. (Jan. 14, 1997), describes a mask utilizing a layer of vacuum packed beads to allow the patient to physically adjust the pressure applied at various points by finger manipulation. U.S. Pat. No. 5,647,357, Respiratory Mask Facial Seal by Barnett et al. (Jul. 15, 1997), describes use of gels possessing resilience or recoil characteristics substantially similar to those of human fat tissue. However the Barnett patent teaches away from using substances which are not similar in consistency to human fat tissue and fails to address the need for curing the gel in a manner which allows for the unique contours of individual facial structures.

The use of silicon as the medium within bladder of a seal has been described in U.S. Pat. No. 6,019,101, Nasal Air Mask by Cotner at al. (Feb. 1, 2000). However, the Cotner patent fails to anticipate the use of the materials utilized within the present invention and is not intended for customization for individual patient needs and facial structures.

The method of making a face mask from facial impressions is described in U.S. Pat. No. 5,832,918, Method Of Making A Face Mask From A Facial Impression And Of Gas Delivery by Pantino (Nov. 10, 1998). However, the method described in the Pantino patent requires that a mold be taken of the patient's face and a hard shell which forms the body of the mask be created from that mold. No mention is made of utilizing curable materials within a seal bladder to customize the fit to the individual patient.

Accordingly, a need exists for a nasal or facial mask which provides an effective customized seal utilizing a method which allows the seal to be created quickly and economically by a physician or respiratory therapist.

### SUMMARY OF THE INVENTION

An improved seal and method for making same is disclosed as useful in a wide variety of applications including, but not limited to, respiratory masks for the treatment of sleep apnea, for use with anesthesia gases, and for the general delivery of breathing gases in medical, flight, and underwater applications. In an exemplary embodiment the seal medium is formed from a liquid oligomer or polymer that is injected into an annular bladder affixed or capable of affixation to a facial mask shell. Mask shells commonly utilized in the medical arts are anticipated to be utilized with the annular bladder and seal medium. Customs mask shells that are uniquely designed for use with the annular bladder and seal medium are also anticipated to be utilized with the present invention.

The seal medium is preferably quickly cured by irradiation or, more preferably by heat, or most preferably by the addition of a curing agent into seal medium within the bladder. Ideally the seal, with its bladder and injected medium, is affixed to a mask to be worn by the patient and subsequently placed on the patient's face during the curing process, thereby a customized seal which conforms to the face of the wearer can be quickly created within the office of a medical professional or potentially at home. Ideally the mask is worn in the same manner during the curing process as will be worn by the patient in the treatment of his respiratory condition. The seal is customizable to the contours of the patient's facial structure as well as to the structure of the mask shell when properly fitted to the patient during the curing process.

It is anticipated that the time required for the curing process can be optimized by accelerating or decelerating the cure rate by processes known to those skilled in the art. It is also anticipated that the cured medium can be cured to differing degrees of firmness and consistency both along the annular bladder and within the medium itself. Pockets of curable material may conceivably be utilized to provide differing degrees of support at different points in an effort to improve the seal between the face and mask.

Ideally the medium employed within the annular bladder is an oligomer or polymer that can quickly be cured by radiation, heat, or chemical additive. The medium should cure to a soft but fairly rigid form that is somewhat flexible so as to deform slightly as the mask is tightened against the face.

Alternative embodiments would accommodate the need to modify the seal by applying pressure either from articulating members on the shell of the mask, deformable areas on the shell of the mask, or by use of inflatable pockets between the seal and face which can accommodate slight variations in placement location on the face and the subsequent need to seal leaks. The inflatable pockets may be linked to be pressurized or depressurized both at once or unlinked so that they may be independently adjusted. The air pockets could be between the face and seal or more preferably be completely within the seal. The inflatable pockets or air bladders could be pressurized manually or via the positive pressure system. The air bladders would be of a construction known to those skilled in the art and would have an internal valve to maintain air pressure until released by the wearer. A manual pump could be of a simple construction such as an air filled external bladder that takes in air as it expands after it is depressed and pumps the air into the bladder as it is depressed.

Additional, non-limiting alternative embodiments include the use of disposable seals capable of affixation to the shell of the facial mask by mechanical means or by means of a deformable sleeve that would stretch over a coupling sleeve. The advantages include improvements in hygiene and cost.

### BRIEF DESCRIPTION OF THE DRAWINGS

FIG. 1 is a rear perspective view of the customizable seal attached to a respiratory mask.

FIG. 2a represents a perspective exploded view of FIG. 1.

FIG. 2b depicts a perspective view of the assembled seal and mask assembly.

FIG. 3a depicts a side perspective view of a preferred embodiment of the seal.

FIG. 3b depicts a side perspective view of an embodiment of the seal utilizing internal air bladders.

FIG. 4 is a cross-sectional view of one embodiment of the seal depicting a means for connecting the seal and mask.

FIG. 5 is a cut-away perspective view of the customizable seal.

FIG. 6 depicts the seal 10 affixed to a mask assembly 20 as worn by the patient.

FIG. 7 depicts the method of injecting a polymeric or oligomeric precursor compound into the internal bladder

### DETAILED DESCRIPTION OF PREFERRED EMBODIMENT

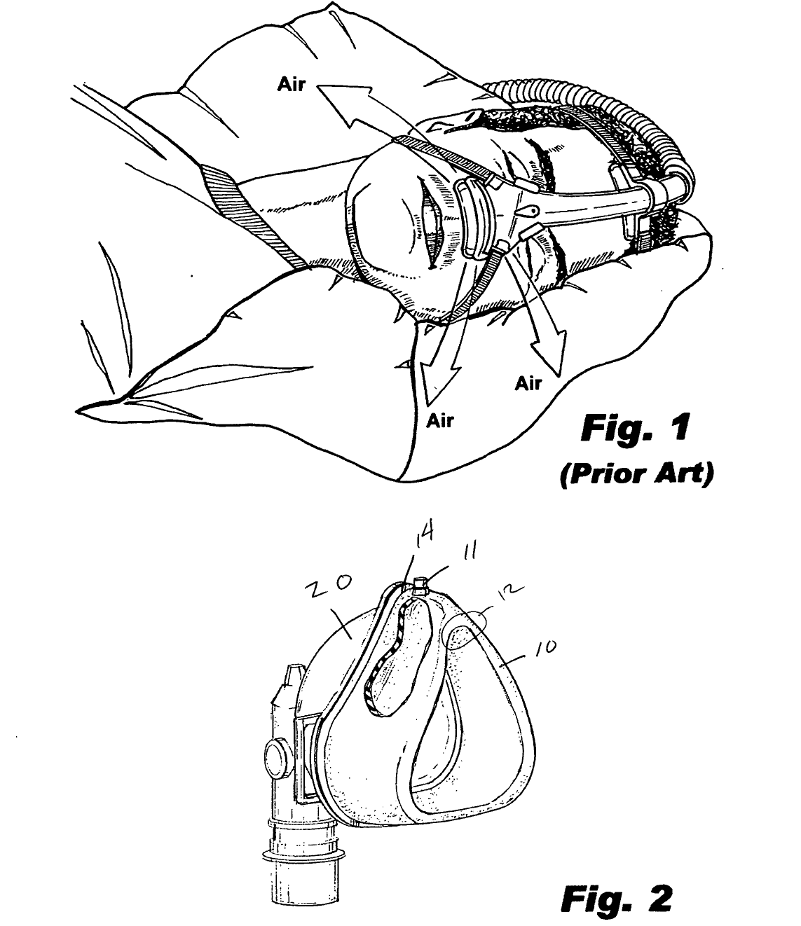

FIG. 1 is a perspective view of a prior art mask and seal demonstrating leakage that can result when gaps between the seal and face of the patient are created as the patient's head moves during sleep.

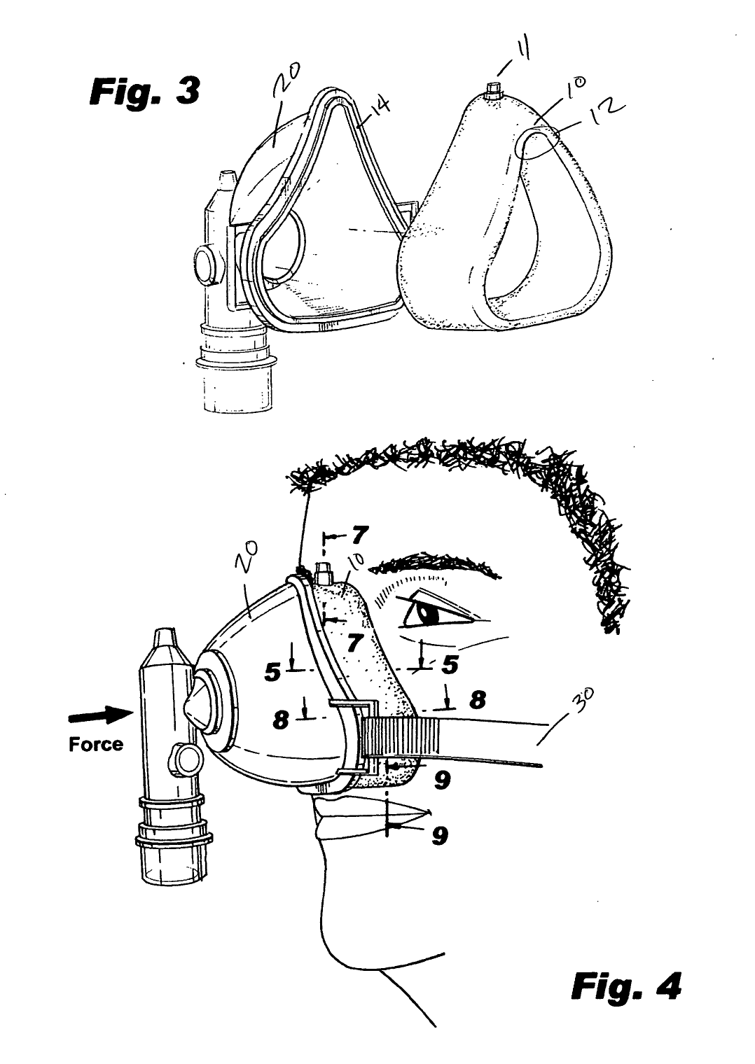

FIG. 2 a rear perspective view of the customizable seal, with cutaway, attached to a respiratory mask. The seal 10 is shown as attached to a respiratory mask assembly 20. The seal 10 has a septum 11 above the nasal bridge 12. The seal 10 is attached to the respiratory mask assembly 20 along the mask/seal interface 13 at the 14 mask/seal joint. The seal 10 features a hollow bladder 15.

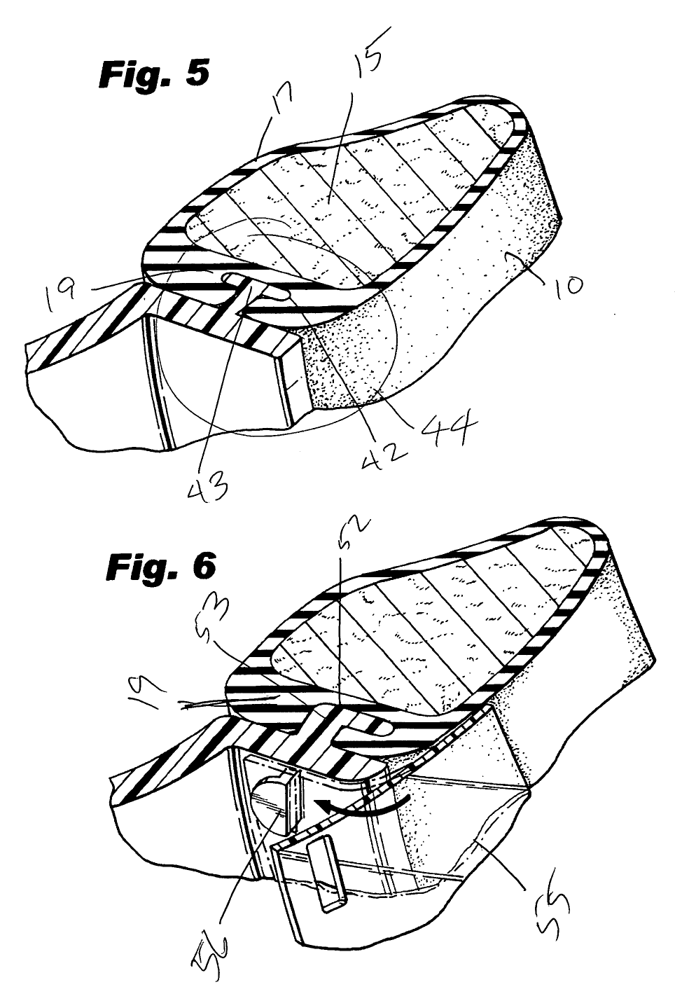

FIG. 3 is an exploded view of FIG. 2.

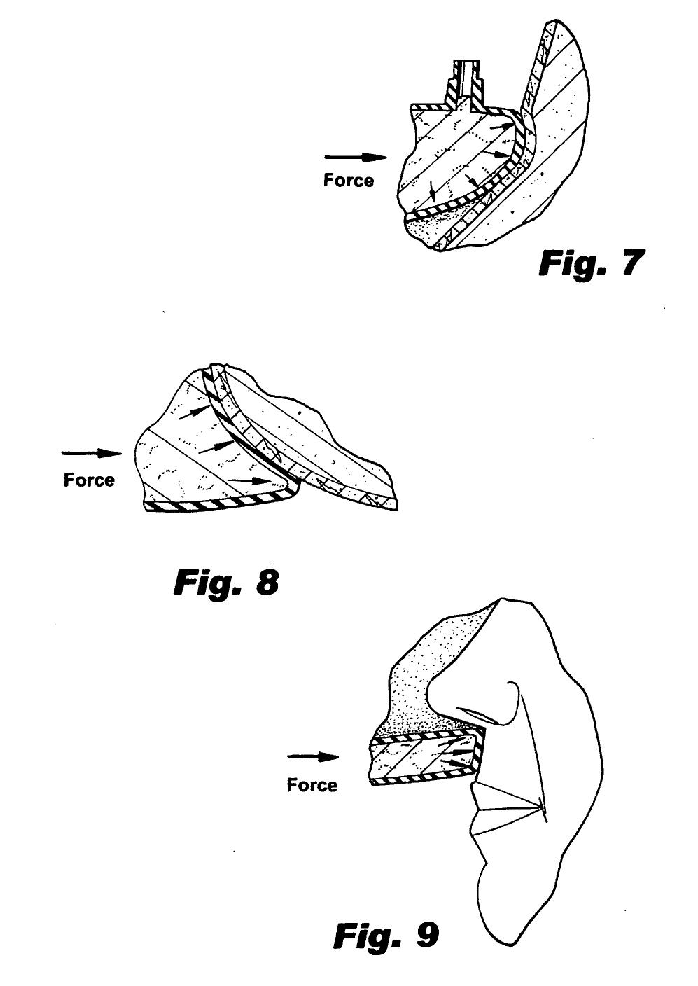

FIG. 4 is a side perspective view of the present invention demonstrating the mask and seal as worn by the patient. The mask 20 is shown to be held in place by a primary strap 30 that passes around the head of the wearer and connects on the opposing side of the mask 20. The seal 10 is shown placed between the mask 20 and the face of the wearer. The mask 20 and seal 10 must function to minimize leakage between the seal 10 and the face. Due to the vast difference in facial topographies between patients, the seal 10 cannot possibly function to effectively eliminate leakage on the soft areas of the face surrounding bony structures of the face without further customization. The primary seal bladder 15, not shown, when used in conjunction with the polymeric or oligomeric material or setting compound introduced into the primary seal bladder 15 through the septum 11, provides the additional support necessary upon hardening while affixed to the face of the intended patient during the curing process.

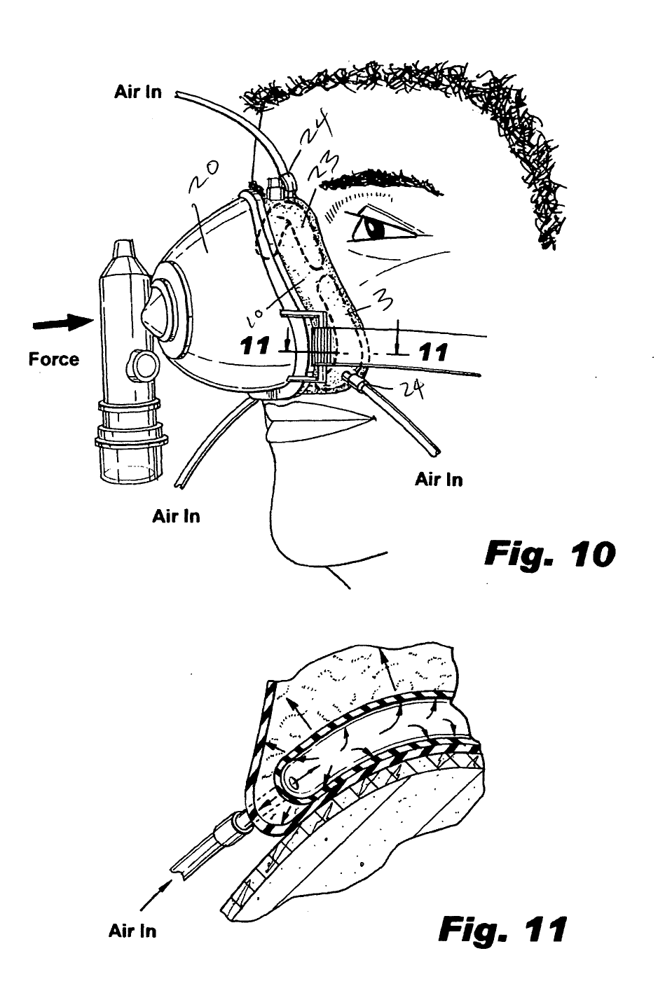

FIG. 5 depicts one method of attachment for affixing the seal 10 to the mask 20. The t-joint connecting means 44 is comprised of the t-connector 43 of the respiratory mask assembly 20 being received into the t-groove 42 of the customizable seal 10 along the seal/mask interface 13. The seal 10, in this non-limiting embodiment, is shown to be joined to the t-groove 42 of the rear internal bladder wall 19. The external bladders walls 17 are also depicted. The internal bladder 14 is expected to be filled with a quick-setting compound that allows the mask to be moldably conformed to the face of the wearer upon setting yet still retain its suppleness.

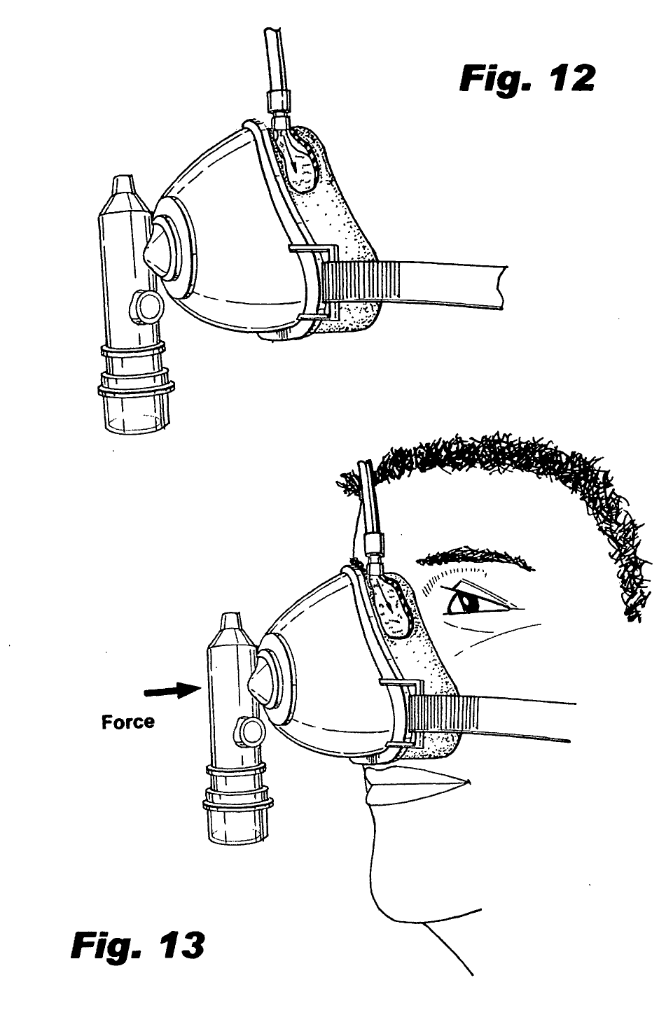

FIG. 6 depicts an alternative embodiment using an L-joint connecting means 54 comprising an L-block 53 and L-groove 52 connection and a seal strap 55 that engages the strap receiving key 56 through the strap keyhole 57.

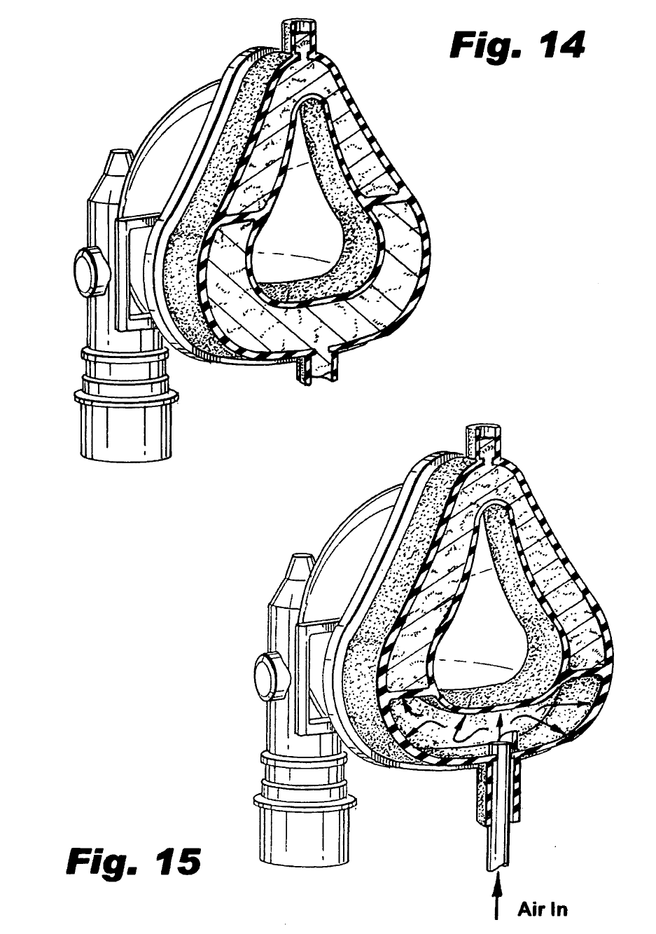

FIGS. 7, 8 and 9 depict the process of using forced introduction of the setting compound to seek out and expand into weak points between the face of the wearer and the seal 10, typically found in areas between bony structures of the face. Upon setting, the seal 10 conforms better to the face of the wearer by the additional rigidity conferred by the setting compound in the areas of the face where leaks are likely to occur.

FIG. 10 depicts a further embodiment of the present invention. Fit adjustment bladders 23 are shown to exist between the primary seal bladder 15 and the face of the wearer. The fit adjustment bladders 23 could either reside within the external walls 17 of the seal 10, not coming into contact with the face of the wearer, or could reside on the surface of the external walls 17. The fit adjustment bladders 23 could be pressurized through fit adjustment bladder septums 24 with air, with additional setting compound, or with a gel or liquid.

FIG. 11 depicts the pressurization of the fit adjustment bladder 23 via the fit adjustment bladder septum 24 and demonstrates its impact on the external bladder wall 17 as well as the transmission of force through the setting compound 18.

FIG. 12 and FIG. 13 provide cutaway views of the present invention being injected or pressurized with the setting compound. FIG. 13 demonstrates the method of introducing the setting compound into the primary seal bladder while being worn by the intended patient. The external bladder wall 17 is partially cutaway to demonstrate the filling of the primary seal bladder 15.

FIG. 14 and FIG. 15 depict further embodiments of the primary seal bladder 15 be compartmentalized to allow for further customization. It is anticipated that setting compounds of differing suppleness and rigidity, or even air, could be used to create custom fits for different compartments. The inclusion of two compartments is a non-limiting example. Further embodiments could utilize as many or as few compartments as necessary. It is also anticipated that a seal need not have a bladder running throughout the seal.

What is claimed is:

1. A seal comprising:
(a) an annular seal for a mask, said seal being of sufficient size for encompassing a predetermined area of the face of the wearer of said mask;
(b) at least one internal bladder within said annular seal;
(c) a curable liquid composition capable of curing to a sufficient resiliency so as to support said seal against said wearer's facial structures and said mask but flexible enough so as to conform to said facial structures of said wearer;
(d) said composition capable of sufficiently curing to maintain its form in less than one hour;
(e) at least one inlet in said bladder through which said liquid composition may be introduced; and
(f) means for attaching said seal to said mask.

2. The seal of claim 1, wherein said means for attaching said seal to said mask has a means for detaching said seal from said mask.

3. The seal of claim 1, wherein said compound is comprised of the group consisting of polyvinylsiloxanes and similar compounds.

4. The seal of claim 1, further comprising a means for sealing said inlet.

5. The seal of claim 1, wherein said seal is a flexible membrane.

6. The seal of claim 5, wherein said membrane is comprised of a polymer.

7. The seal of claim 5, wherein said seal is comprised of materials that resist degradation caused by oils from human skin.

8. The seal of claim 5, wherein said seal is comprised of materials that resist degradation caused by components of said curable liquid composition.

9. The seal of claim 5, wherein said seal is comprised of materials from the group consisting of urethane, latex, neoprene, rubber, and similarly flexible materials.

10. The method of creating a customized seal for a facial mask comprising the steps of:
(a) injecting a curable liquid composition into the internal bladder of a facial seal for a mask,
(b) applying said seal to the face of the intended wearer, and
(c) sufficiently curing said composition while on the face of said intended wearer so that the cured composition maintains its form inside said bladder after removal of said seal from the face of said intended wearer.

11. The method of claim 10, further comprising the step of further curing said composition after removal from said wearer's face.
